(19) United States
(12) Patent Application Publication
(10) Pub. No.: US 2017/0173620 A1
(43) Pub. Date: Jun. 22, 2017

(54) Rain Rocket

(71) Applicant: Cameron Garrett, Cordova, TN (US)

(72) Inventor: Cameron Garrett, Cordova, TN (US)

(21) Appl. No.: 15/373,652

(22) Filed: Dec. 9, 2016

Related U.S. Application Data
(63) Continuation-in-part of application No. 62/268,245, filed on Dec. 16, 2015.

(51) Int. Cl. B05B 15/06; A01G 25/02; B05B 9/01

(52) U.S. Cl. CPC B05B 15/061; B05B 9/01; B05B 15/065; A01G 25/02

(57) ABSTRACT

“The Rain Rocket” is an inexpensive, compact, mobile irrigation device which can be attached to fences, gates, tree limbs, playsets, etc. in order to water lawn and garden areas. Incorporates irrigation head with modified attached spring-loaded C-clamp and treaded female garden hose connector. This unique design allows the apparatus to be attached to objects which elevates sprinkler high off the ground to irrigate more area, quicker and easier than traditional water sprinklers without ever having to bend over. Device can utilize many different nozzle configurations such as pop-up rotating, pop-up static or impact sprinkler heads. Perfect solution for watering difficult parkway, verge and set-back areas by attaching to fence or gate without ever having to leaving your own backyard.

### BACKGROUND

Sprinklers are used to water a lawn or garden and eliminate the need for a person to manually water the lawn or garden with a water can or similar device. However, sprinklers are generally located on the ground, which limits the area that can be watered by the sprinkler. As a result, the person may require the use of multiple additional sprinklers in order to fully water a lawn or garden. Thus, a sprinkler device that can be mounted to various objects and elevated areas that allows the sprinkler to water a larger area is desired.

### SOLUTION

The present invention provides a sprinkler device that can be mounted to various objects. The sprinkler device comprises a housing having a hose connector in fluid communication with a water distributing nozzle. The housing further includes a clamp for affixing the sprinkler to any of various supports, such as a fence, among others. Thus, the sprinkler device allows the user to secure the sprinkler to various objects and elevated areas so as to allow the sprinkler to cover a greater area than conventional ground mounted sprinklers.

### BRIEF DESCRIPTION OF THE DRAWINGS

FIG. 1 shows a front perspective view of the sprinkler device affixed to a fence.

FIG. 2 shows a rear perspective view of the sprinkle device affixed to a fence.

FIG. 3 shows a side perspective view of the sprinkler device.

FIG. 4 shows tech drawing of sprinkler device

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application. to thereby enable others skilled in the art to best utilize the present invention and various embodiments with various modifications as are suited to the particular use contemplated.

### DETAILED DESCRIPTION

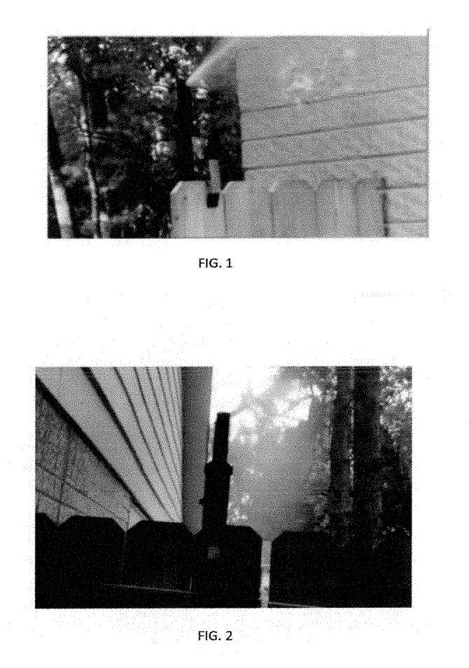

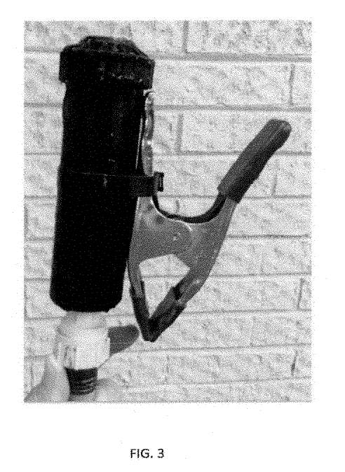

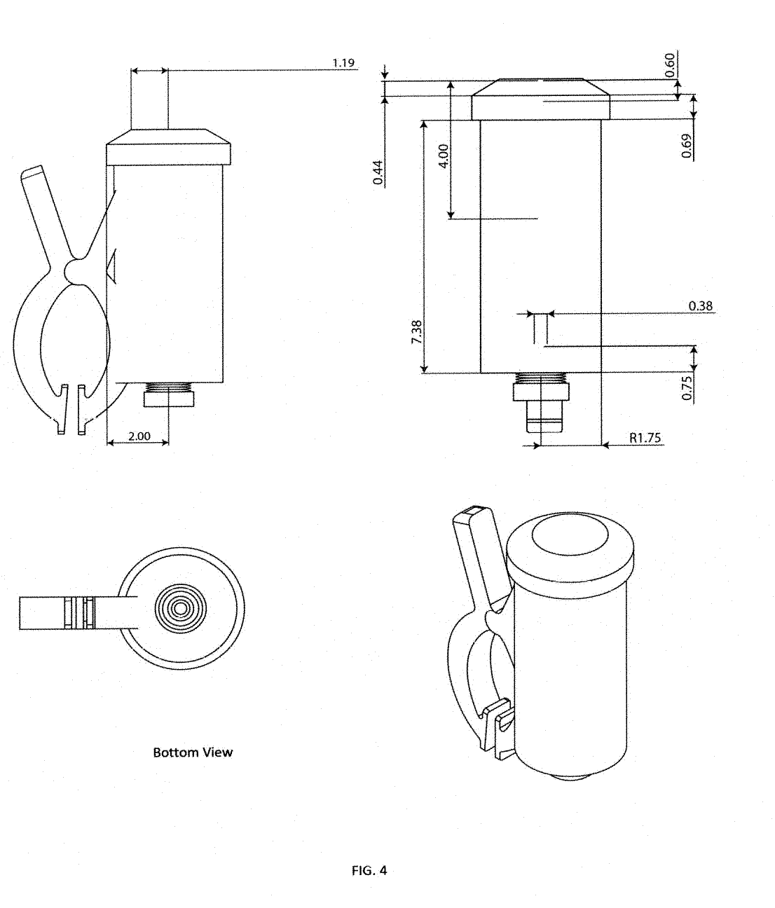

Referring now to FIGS. 1 and 2, there are shown perspective views of the sprinkler device as secured to a fence. The sprinkler device comprises a housing having a hose connector and a water distributing nozzle. The hose connector preferably comprises a threading thereon for receiving the threading of the end of a hose, so that the hose can provide water to the sprinkler device. The nozzle is used to produce a mist or spray for watering the garden or lawn and can have any of various configurations resembling conventional sprinkler heads. In some embodiments, the nozzle can be static or rotate so as to direct the spray of water to various portions of the lawn.

In some embodiments, the clamp can be used to secure the sprinkler device to ‘any of various objects or areas, such as a fence, a gate, a chair, or a branch, among various other areas. In this way. the sprinkler device can be arranged in an elevated position for watering a larger area.

1) A compact, modular, attachable lawn and garden sprinkler device comprising:
(a) a hard plastic elongated irrigation canister head with
(b) an integrated hard plastic spring-loaded C-clamp attached together to said irrigation head with mouth of clamp positioned in a downward fashion and
(c) a plastic treaded female screw-on hose connector attached to center bottom of said irrigation head in which outdoor water hose is attached to one end to said female connector and other end of said hose is attached to any outdoor water faucet.
Whereas when outdoor water is turned on the device disperses water onto lawn or garden from an elevated position of ones choosing.
